(19) United States
(12) Patent Application Publication
(10) Pub. No.: US 2016/0036813 A1
(43) Pub. Date: Feb. 4, 2016

(54) EMULATE VLANS USING MACSEC

(71) Applicant: HEWLETT-PACKARD DEVELOPMENT COMPANY, L.P., Houston, TX (US)

(72) Inventors: Shaun K. Wakumoto, Roseville, CA (US); Craig J. Mills, Roseville, CA (US); Mohamed Parvez Syed, Roseville, CA (US)

(73) Assignee: HEWLETT-PACKARD DEVELOPMENT COMPANY, L.P., Houston, TX (US)

(21) Appl. No.: 14/776,759

(22) PCT Filed: Mar. 15, 2013
(86) PCT No.: PCT/US2013/032185

§ 371 Date: Sep. 15, 2015

(51) Int. Cl. H04L 29/06

(52) U.S. Cl. CPC H04L 63/0876; H04L 63/061; H04L 63/0435

(57) ABSTRACT

Emulating virtual local area networks (VLAN)s using media access control security (MACsec) can include a network controller to provision a first client device of a plurality of client devices within a network with a MACsec key associated with a MACsec flow. The network controller can provision a second client device with the MACsec key associated with the MACsec flow to emulate a VLAN with secure communication between the first and the second client devices.

### BACKGROUND

The Institute of Electrical and Electronics Engineers (IEEE) may specify a number of standards, including, for example IEEE 802.1Q virtual local area network (VLAN) standard, which defines separating traffic on the same physical network device into virtual networks. For example, a VLAN may include a number of local area network (LAN) segments which are on different ports of a switch.

### BRIEF DESCRIPTION OF THE DRAWINGS

FIG. 1 is a diagram illustrating an example of a network according to the present disclosure.

FIG. 2 is a flow chart illustrating an example of a method to emulate VLANs using MACsec according to the present disclosure.

FIG. 3 is a diagram illustrating an example of the use of individual keys in according to the present disclosure.

FIG. 4 is diagram illustrating an example of the use of group keys according to the present disclosure.

FIG. 5 is diagram illustrating an example including group keys for traffic that spans switches according to the present disclosure.

FIG. 6 illustrates an example of a network controller according to the present disclosure.

FIG. 7 illustrates an example of a sequence for validating and indentifying client devices according to the present disclosure.

### DETAILED DESCRIPTION

Virtual area networks (VLAN)s may be used to segregate traffic (e.g., network traffic) in order to reduce the size of a Layer 2 broadcast domain and/or provide security through separation of client traffic. For instance, the institute of Electrical and Electronics Engineers (IEEE) may specify a number of standards, including, for example IEEE 802.1Q VLAN standard, which defines separating traffic (e.g., client traffic) on the same physical network device into virtual networks. Such separation may offer some level of security since traffic from one group of users can be restricted to only the users that are intended to see that traffic.

In the present disclosure, reference is made to the accompanying drawings that form a part hereof, and in which is shown by way of illustration how a number of examples of the disclosure can be practiced. These examples are described in sufficient detail to enable those of ordinary skill in the art to practice the examples of this disclosure, and it is to be understood that other examples can be used and that process, electrical, and/or structural changes can be made without departing from the scope of the present disclosure.

The figures herein follow a numbering convention in which the first digit corresponds to the drawing figure number and the remaining digits identify an element or component in the drawing. Elements shown in the various figures herein can be added, exchanged, and/or eliminated so as to provide a number of additional examples of the present disclosure. In addition, the proportion and the relative scale of the elements provided in the figures are intended to illustrate the examples of the present disclosure, and should not be taken in a limiting sense.

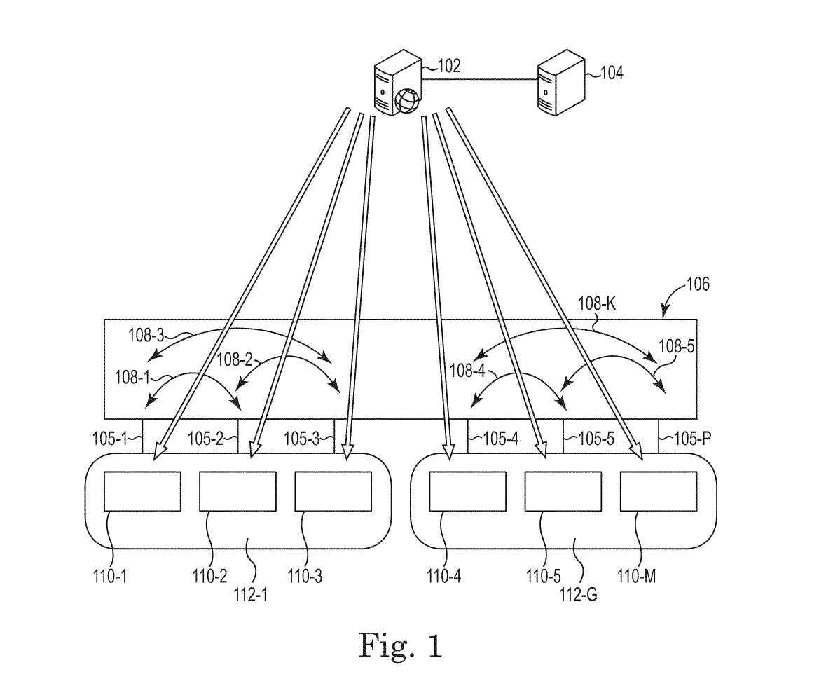

A first VLAN may provide service for a first customer (e.g., customer A) using a predetermined port (e.g., port 1) whereas a second VLAN may provide service for a second customer (e.g., customer B) using another predetermined port (e.g., port 5). VLANs may work well if customers are readily identifiable, trusted, and/or if physical security is maintained for ports associated with each of the customers. However, VLANs are subject to various security concerns, including concerns associated with unknown customers, untrusted customers, and/or a lack of a desired level of security (e.g., physical security). Such concerns may result in security breaches (e.g., customers from different clients from being able to see each other's traffic). For example, a malicious customer from a given group (e.g., group 112-1 associated with ports 105-1, . . . 105-3 as illustrated in FIG. 1) could potentially physically connect their client device (e.g., a laptop) to a port associated with a different customer (e.g., ports 105-4, . . . 105-P associated with group 112-G as illustrated in FIG. 1) to gain access to that customers traffic (e.g., traffic associated with group 112-G)

Media access control security (MACsec) can include a defined data unit (e.g., a packet, a frame, among others) format, which can be similar to an Ethernet frame with additional fields such as a security tag (e.g., an extension of the Ethertype) and message authentication code. The security tag in a data unit (e.g., a MACsec frame) can include an association number within the channel, a data unit number (e.g., a packet number) to provide a unique initialization vector for encryption, for example, MACsec traffic (e.g., an encrypted packet payload) and authentication algorithms as well as protection against replay attack. MACsec can utilize associations (e.g., MACsec secure connectivity associations) that represent groups of switches connected via unidirectional secure channels. Associations within each secured channel use their own encryption/decryption keys, for example, to encrypt/decrypt a data unit (e.g., a packet payload).

According to some previous approaches, switches in a communication path of a MACsec flow may be responsible for negotiating keys using IEEE 802.1X-2010 and the MACsec key exchange agreement (MKA) protocol. Thus, such a MACsec switch has visibility of the traffic on the MACsec switch since the MACsec switch has a valid key for the MACsec flow. That is, the MACsec secure channel terminates at the switch. However, for a secure infrastructure, the entire network (or at least the portions of the network participating in MACsec communication) needed to have MACsec capable switches to transmit such communications, which can be costly to deploy. Such costs can, for example, include costs associated with updating network infrastructure to include MACsec capable hardware (e.g., MACsec capable switches). That is, MACsec was designed to work as a hop-by-hop security mechanism. Key negotiation that occurs at each hop between the switches can provide points of vulnerability (e.g., vulnerability to MAC spoofing) for a MACsec communication. Furthermore, key negotiation at each hop (e.g., at switches) between client devices in a MACsec network can add latency and/or overhead to the MACsec flow. In addition, merely storing keys at the switch can provide its own set of security risks, for example, risks related to attacks sending large quantities of MAC addresses (e.g., an overload attack) to the switch storing the key. Such an overload can overflow a MAC table and/or result in traffic being sent in an unsecure manner, for example, traffic may be sent to client devices in an unknown address communication. That is, client devices that may gain access to traffic that are not intended have access to.

In contrast, a number of examples of the present disclosure can employ methods, network controllers, and machine-readable and executable instructions to emulate VLANs using MACsec. Emulating VLANS using MACsec refers to a network controller 102 defining the associations 108-1, 108-2, 108-3, 108-4, 108-5, . . . , 108-K between the client devices to enable the MACsec flow between the client devices and/or a network controller provisioning the client devices with MACsec keys. Such associations 108-1, . . . , 108-K are within secure channels of communication used by client devices (e.g., client devices 110-1 and 110-2) when communicating with one another.

For example, a network controller can provision a first client device of a plurality of client devices within a network with a media access control security (MACsec) key associated with a MACsec flow. Additionally, the network controller can provision a second client device with the MACsec key associated with the MACsec flow to emulate a virtual local area network (VLAN) with secure communication between the first and the second client devices. According to a number of examples of the present disclosure, the number of devices participating in MACsec can be reduced, for example, by not provisioning switches within the network with a MACsec key. In so doing, the complexity and overhead of doing key exchange protocols on switches themselves can be avoided and/or elimination of risk associated the switches being a potential attack vector.

FIG. 1 is a diagram illustrating an example of a network according to the present disclosure. The network 100 is a Layer 2 network including a network controller 102 (e.g., a software-defined network (SDN) controller). SDN is a form of network virtualization in which the control plane is separated from the data plane and implemented in a software application. Network administrators can therefore have programmable control (e.g., centralized control) of traffic including a data unit, for example, packets, without necessitating physical access to the network's hardware devices. One example of a protocol for SDN is OpenFlow, which is a communications protocol that gives access to the forwarding plane of a client device and/or network device over the network. Network devices are devices that handle (e.g., direct, route, switch, bridge, filter, and/or forward, among others) traffic within a network. Examples of network devices include routers, switches, hubs, bridges, and the like. Client devices are devices that are sources or destinations of traffic within a network and that do not otherwise handle other traffic for the network. Examples of client devices include personal computers, laptops, tablets, smartphones, and the like. Some examples of the present disclosure can operate according to an OpenFlow, or other SDN protocol, and/or a hybrid of an SDN protocol combined with “normal” networking (e.g., distributed control plane networking).

The network controller 102 can be in communication with and/or have control over client devices 110-1, 110-2, 110-3, 110-4, 110-5, . . . 110-M. For example, client devices 110-1, . . . , 110-M can be MACsec enabled client devices. Client devices 110-1, . . . , 110-M can be coupled via a switch 106 that is either MACsec enabled or not. In some examples, the first client device 110-1 can be an endpoint of the MACsec flow and the second client device 110-2 can be an endpoint of the MACsec flow. The switch 106 being between endpoints (e.g., client devices 110-1, 110-2) of the MACsec flow neither encrypt nor decrypt the MACsec flow. While FIG. 1 illustrates a single switch shown as 106, the present disclosure is not so limited. That is, the switch 106 represents a number of switches therebetween (with respect to the MACsec flow) depending on the size of the Layer 2 network 100. In some examples, each switch in the network is not MACsec enabled. In some examples, the first and the second client devices (e.g., client devices 110-1, 110-2) can be endpoints of the MACsec flow. Examples are not limited to the specific number of client devices illustrated in the Layer 2 network 100.

In the example illustrated in FIG. 1, the network controller 102 can establish a first MACsec flow (as represented by associations 108-1, 108-2, and/or 108-3 enabling such a flow) between client device 110-1 and client device 110-2 for communication between client device 110-1 and client device 110-2. That is, in such an example, only the client devices 110-1 and 110-2 will be given keys for such a MACsec flow. The first MACsec flow can include a secure channel (not shown), for example, a unidirectional secure channel, between the switch 106 and the client devices 110-1, . . . , 110-M. The MACsec flow can remain encrypted through the switch 106 while the switch 106 does not have keys for the MACsec flow. Thus, the network controller 102 can provision client device 110-1 and client device 110-2 with key(s) for the MACsec flow, while not provisioning the switch 106 with such key(s). Thus, none of the switches (e.g., switch 106) in the path of the first MACsec flow need to negotiate a key for the MACsec flow with another switch, which can decrease costs and/or overhead associated with the switches and increase throughput of the MACsec flow. The example illustrated in FIG. 1 includes six unique associations 108-1, . . . , 108-K that can be maintained by the switch 106.

According to some previous approaches, if the traffic through switches forces keys to expire often, for example, if there is a large volume of traffic and/or a data unit (e.g., a packet) number hits its max value, as described herein, then switches may spend many processing cycles performing MKA negotiations with its association (e.g., MACsec secure association) neighbors. Furthermore, according to the present disclosure, the switch 106 need not even be MACsec capable as they do not need a key to process the MACsec flow, but can merely pass the data unit along according to their header information, which is not encrypted.

The network controller 102 can include a processing resource in communication with a memory resource. The memory resource can include a set of instructions, executable by the processing resource to perform a number of functions described herein. For example, the network controller 102 can provision a first client device 110-1 (e.g., included in a first group 112-1 that can be associated with ports 105-1, 105-2, 105-3 of the switch 106) with a first MACsec key associated with the MACsec flow, the first MACsec key being based on an association (e.g., association 108-1) between the first client device and a second client device 110-2. The network controller can provision the second client device 110-2 with the first MACsec key associated with the MACsec flow based on the association (e.g., association 108-1). However, the disclosure is not so limited. That is, references to the first client device and/or the second client device are merely illustrative of examples of the present disclosure rather than implying a particular order and/or a particular client device of the plurality of client device associated with a given reference to a first and/or a second client device. For instance, although not depicted as such in FIG. 1, in some examples, the second client device can be a client device (e.g., 110-5) included in a second group 112-G that can, for example, be associated with ports 105-4, 105-5, . . . , 105-P of the switch 106. Client device 110-1 can encrypt the MACsec flow using the key provisioned by the network controller 102, and client device 110-2 can decrypt the MACsec flow using the key provisioned by the network controller 102. That is, the switch 106 between, with respect to the first and the second client devices 110-1, 110-2, is not provisioned with MACsec key(s).

The first client device 110-1, the second client device 110-2, and the network controller 102 can be on a common Layer 2 network 100. Of note, the switch 106 between endpoints (e.g., client devices 110-1, 110-2) of the MACsec flow neither encrypts nor decrypts the MACsec flow. This can be beneficial in reducing the number of network devices that would otherwise have to negotiate MACsec keys and/or be MACsec enabled. For instance, existing switches (e.g., switches that are not MACsec enabled) on existing network may be utilized in accordance with the present disclosure. This can provide a substantial cost savings as currently deployed non-MACsec devices would otherwise need to be replaced with MACsec capable devices in order to support a robust MACsec deployment according to some previous approaches. Many organizations might not be willing to do a “forklift replacement” of their network due to such costs. Any additional latency added by emulating VLANs using MACsec according to the present disclosure should be unnoticeable to most users.

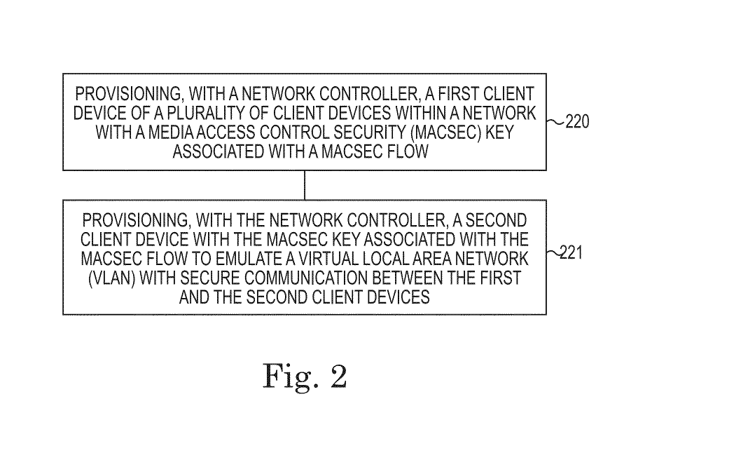

FIG. 2 is a flow chart illustrating an example of a method to emulate VLANs using MACsec according to the present disclosure. At block 220, the method can include provisioning, with a network controller, a first client device of a plurality of client devices within a network with a MACsec key associated with a MACsec flow based on an association including the first client device and the second client device. At block 221, the method can include provisioning, with the network controller, a second client device with the MACsec key associated with the MACsec flow based on the association to emulate a virtual local area network (VLAN) with secure communication between the first and the second client devices.

In some examples, the method can include the first and the second client devices (e.g., client devices 110-1, 110-2) as endpoints of the MACsec flow. In some examples, the method can include encrypting the MACsec flow with the first client device (e.g., client device 110-1) according to the MACsec key, decrypting the MACsec flow with the second client device (e.g., client device 110-2) according to the MACsec key, and not provisioning at least one switch (e.g., switch 106) between, with respect to the first and the second client devices (e.g., client devices 110-1, 110-2), with a MACsec key. Not provisioning refers to not providing at least one switch (e.g., switch 106) between, with respect to the first and the second client devices, with a MACsec key. Provisioning refers to providing a MACsec key to an address (e.g., a MAC address, an IP address, among others) of at least one client device. For example, providing a MACsec key to addresses of the first and the second client devices. Such provisioning can include the network controller indentifying addresses (e.g., addresses of the first and second client devices) as endpoints (e.g., a source address and/or a destination address) of the MACsec flow.

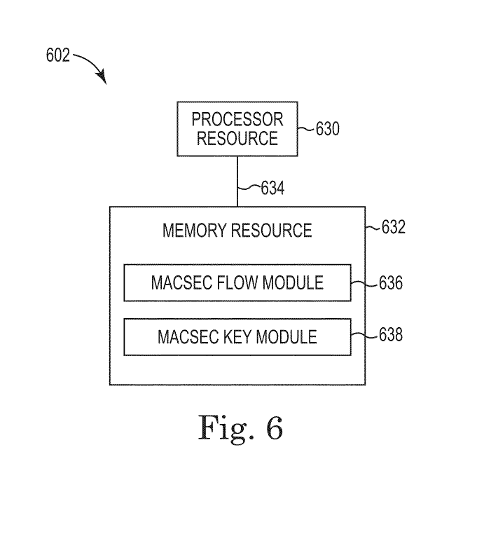

The network controller (e.g., network controller 102) can, in some examples, provision the client devices (e.g., client devices 110-1, . . . , 110-M) with updated MACsec keys as appropriate. In some examples, the network controller 102 can provision various client devices with sets of MACsec keys. In such examples, the network controller 102 can instruct the client devices 110-1, . . . 110-M which of the set of MACsec keys to use for a particular MACsec flow. Using sets of keys is described in more detail below with respect to FIG. 6.

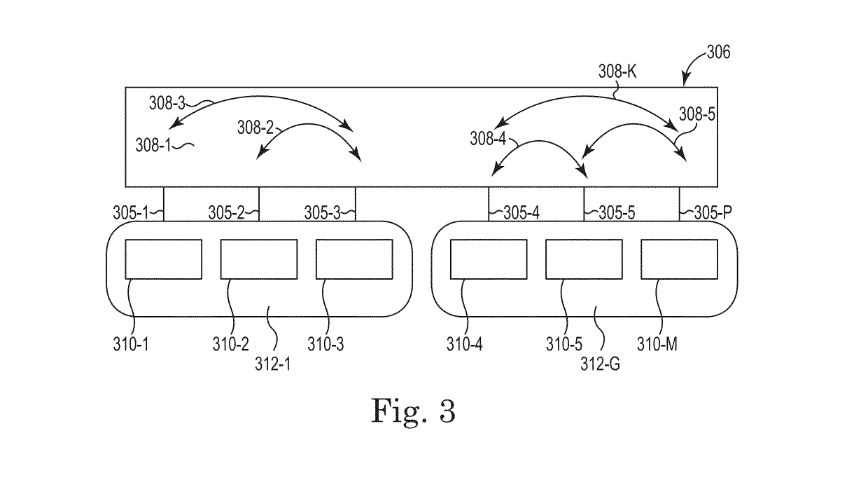

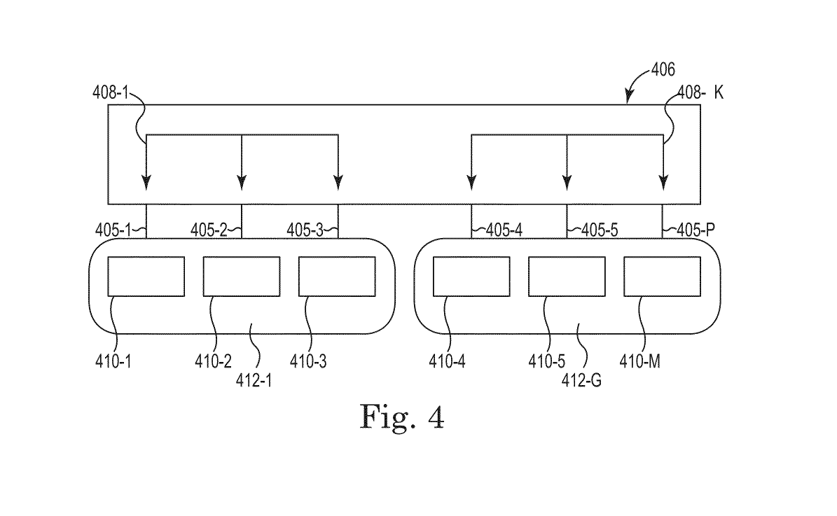

FIG. 3 is a diagram illustrating an example of the use of individual keys in according to the present disclosure. In some examples, when using unicast traffic, only two client devices are able to encrypt and/or decrypt traffic. FIG. 3 illustrates six secure associations 308-1, . . . , 308-K. Such associations can each include a respective individual key that can, for example, be utilized by both client devices for encrypting/decrypting a MACsec flow (e.g., the client devices being associated with ports 305-1, . . . 305-P). For example, client devices 310-1 and 310-2, can utilize such a key with respect to an association 308-1. While such client device can be included in groups 312-1, 312-G (e.g., a group corresponding a given client) the groups and/or client devices 310-1, . . . 310-M do not include a group key. A group refers to at least two of a plurality of client devices (e.g., 310-1, 310-2) having an association 308-1, . . . , 308-K (e.g., secure channels of communication) for communication (e.g., communication between) the at least two client devices. Such groupings of client devices can promote business activities (e.g., billing a particular client utilizing multiple client devices 310-1, . . . 310-M), promote organizational efficiency, promote emulation of VLANs using MACsec, and/or provide secure channels for communications between client devices of a given group. A group key is described in detail with respect to FIG. 4. For example, client devices utilizing such an individual key example have communications (e.g., no secure communications) between client devices belonging to different groups.

FIG. 4 is diagram illustrating an example of the use of group keys according to the present disclosure. For example, a group key enables broadcast communication, multicast communication, and unknown destination address communication, as described herein, among those client devices having the group key. A group key can be provisioned to the at least two of the plurality of client devices (e.g., the first and second client devices 410-1, 410-2). In some examples, the group can include the first and second client devices 410-1, 410-2. In such an example group, a secure channel can be enabled therebetween. In some examples, the secure channel can be a unidirectional secure channel (e.g., enabling one of incoming or outgoing traffic with respect to the at least two client device).

That is, such a group can include associations 408-1, where 408-1 is indicative of multiple associations within the group (e.g., associations among client devices 410-1, 410-2, and 410-3). For instance, FIG. 4, illustrates that the client devices 410-1, . . . 410-M, can be included in groups 412-1, . . . 412-G. As illustrated in FIG. 4, shows the use of a group key between clients devices 410-1, . . . , 410-3 associated with a first group 412-1 and second group 412-G having a second group key between client devices 410-4, . . . , 410-M. Such groups can be associated with particular port(s) (e.g., a predetermined port) 405-1, . . . , 405-P of a switch 406. A network controller, as described herein, can distribute such a group key via the network (e.g., network 100), for example, via the switch 406. Such associations 408-1, . . . , 408-K can, in some examples, be directional (e.g., unidirectional). For example, allowing outbound or inbound communications (e.g., incoming or outgoing traffic) between the at least two client devices of the group.

Secure communications (e.g., network communications) within such a group utilizing secure channels can, in some examples, include broadcast, multicast, and/or unknown address communications based on associations including the first and the second client device. Broadcast communications refer to providing traffic known client device address(es) (e.g., using a broadcast address), for example, via the network controller and/or the switch 406, to each of the plurality of client devices 410-1, . . . 410-M (e.g., client devices having a known broadcast address). Multicast traffic refers to providing a single communication to at least two of the client devices 410-1, . . . 410-M (e.g., streaming media applications). An unknown address communication is similar to a broadcast communication but lacks a known client device destination for a given data unit (e.g., lacks a broadcast address). For example, an unknown address communication can include to providing traffic to all of the client devices 410-1, . . . 410-M except for a client device (e.g., client device 410-3) that originally received the communication on the Layer 2 network, as described herein. In some examples, the network controller to enable the first and second client devices 410-1, 410-2 to encrypt and decrypt a broadcast communication, a multicast communication, or an unknown address communication via the secure channels therebetween according to the group key.

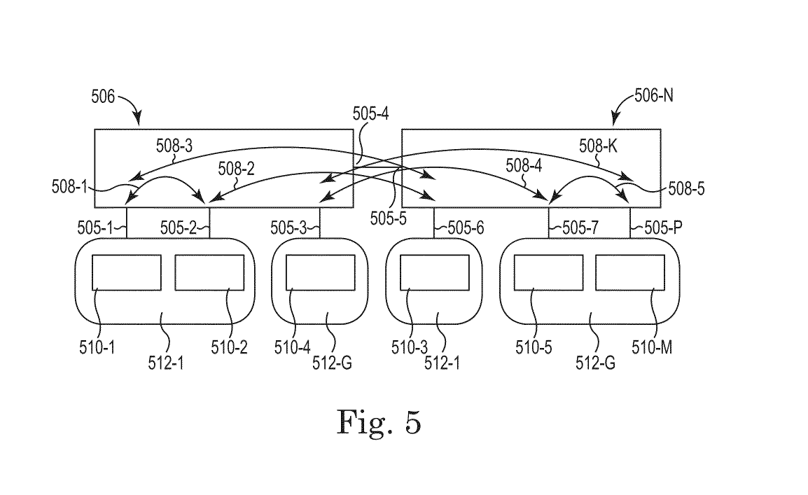

FIG. 5 is diagram illustrating an example including keys for traffic that spans switches according to the present disclosure. In some examples, a network controller, as described herein, can provision client devices with keys for associations that can span between different switches 506-1, 506-N of the plurality of switches 506-N. FIG. 5 illustrates two switches 506-1, 506-N having ports 505-1, . . . 505-4 and ports 505-5, . . . 505-P, respectively. The associations 508-1, . . . 508-A (e.g., unicast secure communications) are the same as in FIG. 4 except that some traffic can span multiple switches 506-1, 506-N. Client devices 510-1, 510-2, and 510-4 are coupled to switch 506-1 and client devices 510-3, 510-5, and 510-6 reside on switch 506-N. As illustrated in FIG. 5, if a group (e.g., group 512-1) includes client devices (e.g., client devices 510-1, 510-3) that are couple to different switches connected via ports (e.g., ports 505-4, 505-5). Such traffic spanning the switches 506-1, 506-N is secure when it is forwarded across such a span (e.g., between ports 505-4 and 505-5).

FIG. 6 illustrates an example of a network controller according to the present disclosure. The network controller 602 can be analogous to the network controller 102 illustrated in FIG. 1. The network controller 602 can utilize software, hardware, firmware, and/or logic to perform a number of functions.

The network controller can be a combination of hardware and program instructions to perform a number of functions (e.g., actions). The hardware, for example, can include a number of processing resources 630 and a number of memory resources 632, such as a machine-readable medium (MRM) or other memory resources 632. The memory resources can be internal and/or external to the network controller 602 (e.g., the network controller can include internal memory resources and have access to external memory resources). The program instructions (e.g., machine-readable instructions (MRI)) can include instructions stored on the MRM to implement a particular function. The set of MRI can be executable by the processing resources 630. The memory resources 632 can be coupled to the network controller 602 in a wired and/or wireless manner. For example, the memory resources 632 can be an internal memory, a portable memory, a portable disk, and/or a memory associated with another resource, e.g., enabling MRI to be transferred and/or executed across a network such as the Internet.

Memory resources 632 can be non-transitory and can include volatile and/or non-volatile memory. Volatile memory can include memory that depends upon power to store information, such as various types of dynamic random access memory (DRAM) among others. Non-volatile memory can include memory that does not depend upon power to store information. Examples of non-volatile memory can include solid state media such as flash memory, electrically erasable programmable read-only memory (EEPROM), phase change random access memory (PCRAM), magnetic memory such as a hard disk, tape drives, floppy disk, and/or tape memory, optical discs, digital versatile discs (DVD), Blu-ray discs (BD), compact discs (CD), and/or a solid state drive (SSD), etc., as well as other types of machine-readable media.

The processing resources 630 can be coupled to the memory resources 632 via a communication path 634. The communication path 634 can be local or remote to the network controller 602. Examples of a local communication path 634 can include an electronic bus internal to a machine, where the memory resources 632 are in communication with the processing resources 630 via the electronic bus. Examples of such electronic buses can include Industry Standard Architecture (ISA), Peripheral Component Interconnect (PCI), Advanced Technology Attachment (ATA), Small Computer System Interface (SCSI), Universal Serial Bus (USB), among other types of electronic buses and variants thereof. The communication path 634 can be such that the memory resources 632 are remote from the processing resources 630, such as in a network connection between the memory resources 632 and the processing resources 630. That is, the communication path 634 can be a network connection. Examples of such a network connection can include local area network (LAN), wide area network (WAN), personal area network (PAN), and the Internet, among others.

As shown in FIG. 6, the MRI stored in the memory resources 632 can be segmented into a number of modules 636, 638 that when executed by the processing resources 630 can perform a number of functions. As used herein a module includes a set of instructions included to perform a particular task or action. The number of modules 636, 638 can be sub-modules of other modules. For example, a MACsec flow module 636 can be a sub-module of a MACsec key module 636 and/or the MACsec flow module 636 and the MACsec key module 638 can be contained within a single module. Furthermore, the number of modules 636, 638 can comprise individual modules separate and distinct from one another. Examples are not limited to the specific modules 636, 638 illustrated in FIG. 6.

The network controller 602 can include a MACsec flow module 636, which can specify a first client device and a second client device as endpoints of a MACsec flow. The network controller 602 can include a MACsec key module 638, which can provision a first client device of a plurality of client devices within a network with a MACsec key associated with a MACsec flow based on an association including the first client device and the second client device. The MACsec key module 638 can provision, with the network controller, a second client device with the MACsec key associated with the MACsec flow based on the association to emulate a virtual local area network (VLAN) with secure communication between the first and the second client devices. However, the disclosure is not so limited. That is, the network controller 602 can include a MACsec flow module 636 to specify any of the client devices as endpoints of the MACsec flow.

The network controller 602 can instruct the client devices to be provisioned based on the association between the first and the second client devices include instructions to enable a secure channel between the first client device and the second client device. The network controller 602 can include instructions not to provision a plurality of switches (e.g., network switches) between, with respect to the first and the second client devices, with a MACsec key. The network controller 602 can include instructions to provision a first MACsec key to memory, such as memory described herein, associated with the first client device and/or to provision the second client device with a second MACsec key to memory associated with the second client device. The network controller 602 can include instructions to provision the first and the second client devices with symmetric MACsec keys.

The network controller 602 can, in some examples, enable a secure channel between the first and the second client devices of a plurality of client devices. For instance, associations can enable traffic (e.g., unicast traffic) in a secure channel between the first and the second client devices. For example, traffic to and/or from the first client device, with respect to the second client device.

In some examples, the network controller 602 can define associations to enable secure channels, for example, among a group of the plurality of client devices. Such a group includes at least two of the plurality of client devices. In some examples, the group can include the first and second client devices. A group key can be provisioned to each of the at least two of the plurality of client devices. Associations, such as those defined for a group, can be directional, as described herein. Secure communications (e.g., network communications) within such a group utilizing secure channels can, in some examples, include broadcast, multicast, and/or unknown address communications, as described herein.

The network controller 602 can instruct the client devices to use a different MACsec key from the set of MACsec keys after a given amount (e.g., a predetermined number) of data units have been encrypted/decrypted. A data unit (e.g., MACsec packets) can include a 32-bit data unit number that is incremented with the data unit in order to protect against replay attacks. When the data unit number hits its max value, a new MACsec key may be used (e.g., either the network controller 602 can provision respective client devices with a new key, instruct the respective client devices to use a new key from the set of keys, or the client devices can automatically use a next key in the set). A 32-bit data unit number corresponds to 4,294,967,296 data units.

The network controller 602 can instruct client devices to use a different MACsec key from the set of MACsec keys after a period of time and/or the network controller 602 can instruct the client devices to use a different MACsec key from the set of MACsec keys according to a bandwidth of a link between the client devices. For example, 64-byte data units on a 100 megabits per second (Mbps) link will result in 1,562,500 data units per second, thus the MACsec key can be updated every 45 minutes. On a 1 gigabit per second (Gbps) link, the MACsec key can be updated every 4.5 minutes. On a 10 Gbps link, the MACsec key can be updated every 27 seconds. Provisioning client devices with sets of keys (e.g., as opposed to provisioning the client devices with a new individual key each time it is updated) can reduce overhead for the network controller 602 and/or reduce delay in updating MACsec keys on the client devices, particularly for networks with fast links. Such examples can be particularly advantageous as compared to some previous approaches that necessitate key negotiation between each Layer 2 switch that participated in a MACsec flow.

In some examples, the network controller 602 (e.g., a SDN controller, as described herein) can validate client devices coupled to the network (e.g., network 100). The network controller 602 can, for example, distribute the MACsec keys for all associations in response to such identification. Identification can include recognition of new client devices (e.g., new to a given network) and/or validation of existing clients within the given network.

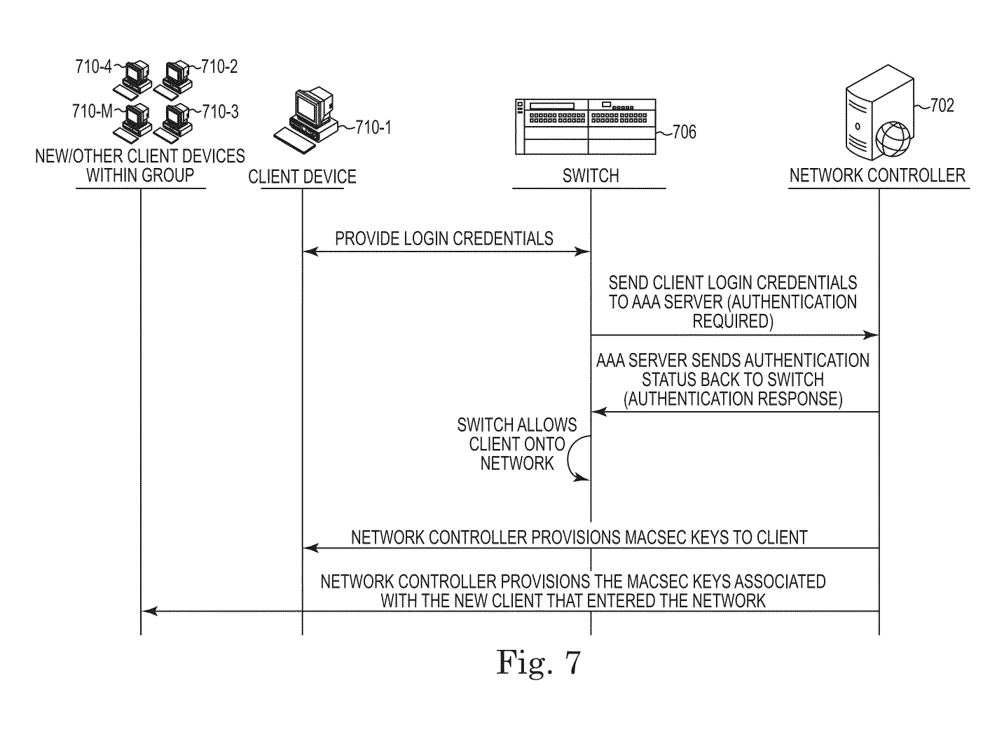

FIG. 7 illustrates an example of a sequence for validating and indentifying client devices according to the present disclosure. As illustrated in FIG. 7, validation of client devices 710-1, 710-2, 710-3, 710-4, 710-M can, for example, include a Network Access Control (NAC) (not shown) coupled to the network controller 702 that is coupled to a switch 706 to provide key distribution (e.g., a centralized key distribution) through the network controller to client devices 710-1, . . . 710-M. The NAC can control access to the network, for example, access to traffic through a network port, through identification and/or validation of client devices 710-1, . . . 710-M within the network. In some examples, identification and/or validation can include providing login credentials via a client device 710-1, . . . 710-M, for example, using the IEEE 802.1x standard, among others. Such credentials can include MAC addresses and/or Internet protocol (IP) addresses, among other information, to promote identification and/or validation of the client device(s). The network controller 702 can, periodically and/or upon an input (e.g., an input provided via a client device), scan the network to indentify new client devices (e.g., a new MAC address attached to the network) and/or validate the client devices 710-1, . . . 710-M within the network.

In some examples, the network controller 702 can include instructions to allow the plurality of client devices access to the network in response to authentication of the plurality of client devices 710-1, . . . 710-M. The network controller 702 can be coupled to a server 704 (e.g., an authentication, authorization, and accounting server) that can store associations, as described herein. The network controller can define (e.g., add, delete, and/or modify) such associations. For example, following identification of a client device (e.g., 710-1) the network controller 702 can add an association between and/or among the indentified client device 710-1 and at least one other of the other client devices 710-2, . . . 710-M. The server 704 can authorize the client devices 710-1, . . . 710-M to access the network based upon associations stored in the server 704. The network controller can provision the client devices 710-1, . . . 710-M based on such associations with MACsec keys to enable communication (e.g., traffic) therebetween.

Modification of an association can include the addition and/or removal of a client device from a group of client devices and/or updating the association, for example, updating a association to enable directional (e.g., unidirectional communications), among other updates to promote emulation of virtual local area network (VLAN)s using media access control security (MACsec). Such updating, adding, and/or deletion of association can include updating a MACsec key, as described herein, associated with a client device included in the updated, added, and/or deleted association.

As used herein, “logic” is an alternative or additional processing resource to perform a particular action and/or function, etc., described herein, which includes hardware, e.g., various forms of transistor logic, application specific integrated circuits (ASICs), etc., as opposed to computer executable instructions, e.g., software firmware, etc., stored in memory and executable by a processor.

As used herein, “a” or “a number of” something can refer to one or more such things. For example, “a number of client devices” can refer to one or more client devices.

The above specification, examples and data provide a description of the method and applications, and use of the system and method of the present disclosure. Since many examples can be made without departing from the spirit and scope of the system and method of the present disclosure, this specification merely sets forth some of the many possible example configurations and implementations.

What is claimed:

1. A method, comprising:
provisioning, with a network controller, a first client device of a plurality of client devices within a network with a media access control security (MACsec) key associated with a MACsec flow; and
provisioning, with the network controller, a second client device with the MACsec key associated with the MACsec flow to emulate a virtual local area network (VLAN) with secure communication between the first and the second client devices.

2. The method of claim 1, wherein the first and the second client devices comprise endpoints of the MACsec flow, and wherein the method includes:
encrypting the MACsec flow with the first client device according to the MACsec key;
decrypting the MACsec flow with the second client device according to the MACsec key; and
not provisioning a network switch between, with respect to the first and the second client devices, with a MACsec key.

3. The method of claim 1, wherein the method includes provisioning the first and the second client devices with an updated MACsec key.

4. The method of claim 1, wherein provisioning the first client device with the MACsec key comprises provisioning the first client device with a set of MACsec keys; and
wherein provisioning the second client device with the MACsec key comprises provisioning the second client device with the set of MACsec keys.

5. The method of claim 4, wherein the method includes instructing the first client device and the second client device to use one of the set of MACsec keys.

6. A non-transitory machine-readable medium storing instructions executable by a network controller to cause the network controller to:
specify a first client device and a second client device as endpoints of a media access control security (MACsec) flow;
provision, with the network controller, the first client device of a plurality of client devices within the network with a MACsec key associated with the MACsec flow based on an association including the first and the second client devices; and
provision, with the network controller, the second client device with the MACsec key associated with the MACsec flow based on the association to emulate a virtual local area network (VLAN) with secure communication between the first and the second client devices.

7. The medium of claim 6, wherein the instructions to provision the second client device with the MACsec key include instructions executable by the network controller to enable a secure channel between the first client device and the second client device.

8. The medium of claim 6, wherein the instructions are executable to cause the network controller not to provision a plurality of network switches between, with respect to the first and the second client devices, with a MACsec key.

9. The medium of claim 6, wherein the instructions to provision the first client device with the MACsec key and the instructions to provision the second client device with the MACsec key include instructions executable by the network controller to provision the first and the second client devices with symmetric MACsec keys.

10. The medium of claim 6, wherein the instructions to provision the first client with the MACsec key include instructions executable by the network controller to provision the first MACsec key to memory associated with the first client device, and wherein the instructions executable to provision the second client device with the MACsec key include instructions executable by the network controller to provision the second MACsec key to memory associated with the second client device.

11. The medium of claim 6, wherein the instructions to provision the first client device with the MACsec key and the instructions to provision the second client device with the MACsec key include instructions executable by the network controller to provision a group key among a group of client devices, the group comprising at least two of the plurality of client devices, including the first and second client devices, having a number of secure channels therebetween, wherein at least one of the secure channels is unidirectional with respect to the first and second client devices.

12. The medium of claim 6, wherein the instructions to provision the first client device with the MACsec key and the instructions to provision the second client device with the MACsec key include instructions executable by the network controller to provision a group key among a group of client devices, the group comprising at least two of the plurality of client devices having a number of secure channels therebetween to enable the first and second client devices to encrypt and decrypt a broadcast communication, a multicast communication, or an unknown address communication via the secure channels therebetween according to the group key.

13. A network controller, comprising:
a processing resource in communication with a memory resource, wherein the memory resource includes a set of instructions to:
define associations between a plurality of client devices to enable a media access control security (MACsec) flow between the plurality of client devices;
provision, with a network controller, a first client device of the plurality of client devices within a network with a MACsec key associated with the MACsec flow based on an association including the first client device and a second client device;
provision, with the network controller, the second client device with the MACsec key based on the association including the first and the second client devices to emulate a virtual local area network (VLAN) with secure communication between the first and the second client devices; and
not to provision each of a plurality of network switches with a MACsec key, the plurality of network switches being between the first and the second client devices with respect to the MACsec flow.

14. The network controller of claim 13, wherein the first client device comprises an endpoint of the MACsec flow and wherein the second device comprises an endpoint of the MACsec flow, and wherein the first client device, the second client device, and the network controller are on a common Layer 2 network.

15. The network controller of claim 13, wherein the instructions are executable by the processing resource to allow the plurality of client devices access to the network in response to authentication of the plurality of client devices.
